(19) United States
(12) Patent Application Publication
(10) Pub. No.: US 2006/0035554 A1
(43) Pub. Date: Feb. 16, 2006

(54) Textile fabric structure

(75) Inventors: Rupert Hermann Josef Glaser, Horlkofen (DE); Stefan Jung, Munich (DE); Christl Lauterbach, Hohenkirchen-Siegertsbrunn (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/207,599

(22) Filed: Aug. 19, 2005

Related U.S. Application Data
(63) Continuation of application No. PCT/DE04/00314, filed on Feb. 19, 2004.

(30) Foreign Application Priority Data
Feb. 21, 2003 (DE) 103 07 505.4

(51) Int. Cl. H02G 3/04; D03D 15/00

(52) U.S. Cl. 442/301; 442/181; 174/68.1

(57) ABSTRACT

A textile fabric structure having a plurality of microelectronic components, which are arranged in the textile fabric structure, electrically conductive threads, which couple the plurality of microelectronic components to one another, conductive data transmission threads, which couple the plurality of microelectronic components to one another, and electrically nonconductive threads. The conductive threads and the conductive data transmission threads at the edge of the textile fabric structure are each provided with an electric interface and a data transmission interface.

### CROSS-REFERENCE TO RELATED APPLICATION

This application is a continuation of International Patent Application Serial No. PCT/DE2004/000314, filed Feb. 19, 2004, which published in German on Sep. 10, 2004 as WO 2004/076731, and is incorporated herein by reference in its entirety.

### FIELD OF THE INVENTION

The invention relates to a textile fabric structure, a surface covering structure and a method for determining the interspacing of microelectronic elements of the textile fabric structure with respect to at least one reference position.

### BACKGROUND OF THE INVENTION

In many areas in building installation technology and in many trade fair structures there is a need to lay sensors and actuators, preferably indicating elements, in a simple way in floors, walls or ceilings. In this case, the intention is for floors, walls or ceilings, alternately or in combination, to be able to perceive contact and/or pressure and to react to the existence of contact and/or a pressure with an optical indication or an acoustic indication.

The requisite large-area sensors or the large-area indicating units are to be capable of being fitted and operate in a simple, cost-effective and fault-tolerant manner. In particular, the installation of the sensors and actuators should be capable of adaptation to various sizes and geometric shapes of a floor, a wall or a ceiling.

In order to integrate sensors and actuators into a floor, a side wall or the ceiling of a room, it is known to lay the desired sensors and actuators in the floor, the wall or the ceiling in a customer-specific solution.

The special solutions require a great deal of effort on planning, in each case it having to be specified exactly when planning the building at which locations the respective sensors and actuators are to be provided.

A further disadvantage in such a special solution is that each sensor and each actuator is driven individually and is in each case provided separately with power lines and data lines. The data lines have been led to a central computing unit individually or via routers to be installed separately. Furthermore, according to the prior art, complex control software is required to drive the respective sensors and actuators, which has to be matched to the specific geometry of the respective special solution in order to permit three-dimensional or planar registration of objects, in particular of persons.

Such special solutions are thus unsuitable for the mass market, since they are inflexible and inexpensive.

Furthermore, T. F. Sturm, S. Jung, G. Stromberg, A Stöhr, A Novel Fault-tolerant Architecture for Self-Organizing Display and Sensor Arrays, International Symposium Digest of Technical Papers, volume XXXIII, No. II, Society for Information Display, Boston, Mass., May 22 to 23, 2002, pages 1316 to 1319, 2002, discloses a fault-tolerant architecture of self-organizing indicating fields and sensor fields in the microelectronics area, expressed in another way in the area of a microsystem.

In German patent application DE 102 02 123 A1, which was published subsequently, an apparatus having a textile material is proposed in which flexible wire-like and/or thread-like electric conductors are arranged. Furthermore, at least one electronic component is connected electrically to the conductor by means of a contact point. A first, hard encapsulation covers the contact point and stabilizes it mechanically. A second encapsulation is designed in such a way that it permits a mechanical connection between the component and the textile material.

DE 196 52 236 A1 describes a fabric of a monitoring element for installation in conveyor belts, the fabric comprising a continuous fabric length having fabric elements and electrically nonconductive material such as plastic threads or rubber threads or textiles threads and electrically conductive fabric elements predominantly at the outer edges.

### SUMMARY OF THE INVENTION

The invention provides a textile fabric structure, a surface covering structure and a method for determining the interspacing of microelectronic components of the textile fabric structure with respect to at least one reference position.

A textile fabric structure has a plurality of microelectronic components which are arranged in the textile fabric structure, electrically conductive threads which couple a plurality of microelectronic components to one another, conductive transmission threads which couple a plurality of microelectronic components to one another, and electrically nonconductive threads. Furthermore, the conductive threads and the conductive data transmission threads at the edge of the textile fabric structure are in each case provided with electric interfaces and, respectively, data transmission interfaces.

### BRIEF DESCRIPTION OF THE DRAWINGS

Exemplary embodiments of the invention are illustrated in the figures and will be explained in more detail below. In the figures, identical components are provided with identical designations.

In the figures:

FIG. 1 shows a textile fabric structure according to the invention as a coarse mesh fabric having conductive threads and integrated microelectronics, four regions a), b) , c) and d) being marked in the figure;

FIG. 2 shows a design study of a textile fabric structure, on which a dark carpet is fixed in subregions;

FIG. 3 shows a schematic representation of a regular 11×11 network of microelectronic components of a textile fabric structure according to the invention; and

FIG. 4 shows a schematic plan view of a textile structure having microelectronic components in a regular square grid.

### DETAILED DESCRIPTION OF PREFERRED EMBODIMENTS OF THE INVENTION

A textile fabric structure is provided which can be used for covering surfaces, preferably a floor, a wall or a ceiling. The textile fabric structure can be used in any desired textile fabrics, for example including curtains, textile roller blinds or awnings. The textile fabric structure has a plurality of microelectronic components for electronic data processing, which plurality of microelectronic components can be supplied with power via electrically conductive threads likewise provided in the textile fabric structure and which are fed with the data to be processed by means of the data transmission threads or can transmit via the latter. As a result of its construction, the textile fabric structure has the advantage over the prior art that it can be produced with a large area and can be cut simply to any desired shape. Thus, it can be adapted to any desired area on which it is to be laid. It is not necessary to couple the individual microelectronic components, such as LEDs, sensors, actuators or processing units, to one another subsequently, since the microelectronic components are already coupled to one another within the textile fabric structure.

Expressed in other words, this means that a plurality of microelectronic components is embedded in a textile fabric structure for covering a surface. On account of components which are additionally provided, the individual microelectronic components are preferably capable of exchanging electronic messages with other microelectronic components in the textile fabric structure via the data transmission threads and thus, for example, to permit local determination of the position of the respective microelectronic components within the textile fabric structure or with respect to a predefined reference position, that is to say to carry out self-organization.

It is thus made possible to determine the position of a microelectronic component within an area very simply without additional external information, even if a textile fabric structure has been brought into a predefined shape by cutting, it being possible for microelectronic components or coupling lines between the individual microelectronic components to be destroyed or removed by the cutting.

Therefore, in the case of self-organization of microelectronic components, it is made possible to configure a textile fabric structure for the mass market in a very simple and cost-effective manner and, in order to lay the textile fabric structure, to tailor the textile fabric structure in accordance with a predefined, desired shape and, despite the additional electronics integrated into said structure, not to have to pay attention to the positions at which the microelectronic components are arranged within the area covered by the latter in order that the respective microelectronic components within the textile structure can be addressed unambiguously.

A surface covering structure has a textile fabric structure on which a surface covering is fixed. The fixing is preferably carried out by means of adhesive bonding and/or laminating and/or vulcanizing.

In the method for determining the interspacing of microelectronic components of a textile fabric structure with respect to at least one reference position by exchanging electronic messages between mutually adjacent microelectronic components, the first message is generated by a first microelectronic component, the first message containing a first item of distance information, which contains the distance of the first microelectronic component or the distance of a second microelectronic component receiving the first message from the reference position. The first message is sent by the first microelectronic component to the second microelectronic component. Depending on the distance information, the distance of the second microelectronic component from the reference position is determined or stored. Furthermore, a second message is generated by the second microelectronic component, which contains a second item of distance information, which contains the distance of the second microelectronic component or the distance of a third microelectronic component receiving the second message from the reference position. The second message is sent by the second microelectronic component to the third microelectronic component. Depending on the second item of distance information, the distance of the third microelectronic component from the reference position is determined or stored. The method steps described above are carried out for the interconnected microelectronic components of the textile fabric structure.

Therefore, after this method has been carried out, the respective position of each microelectronic component within the textile fabric structure and its distance with respect to at least one reference position has been determined merely by using local information.

Clearly, this aspect of the invention can be seen in the fact that an architecture developed for microsystems and there for micro data display devices and sensors, and algorithms developed for the purpose, have been transferred to the microsystems for building services technology and trade fair technology, the necessary microelectronic components being embedded in the textile fabric structure, on which elements of a covering can be fixed.

In this way, a plethora of possible applications opens up, which are explained in more detail in the following text.

The reference position can in principle be any desired; the reference position is preferably a position at which there is a portal processor, described below, which drives the microelectronic components of the textile fabric structure and initiates the communication from outside the textile fabric structure. The portal processor can be a microelectronic component of the textile fabric structure or an additional processor. Furthermore, the reference position can be a position within the textile fabric structure, in this case a microelectronic component preferably being arranged at the reference position and being assigned to the latter. In this case, the reference position is preferably located at the edge, that is to say in the highest or lowest row or the left-hand or right-hand column for the case in which the microelectronic components are arranged in rows and columns in the form of a matrix in the textile structure. The transmission of information into or out of the textile fabric structure is preferably carried out by means of the portal processor exclusively via at least some of the microelectronic components located at the edge of the textile fabric structure.

Clearly, this procedure means that, starting from an “initiating microelectronic component” at the reference position, normally at the edge of the textile fabric structure, that is to say at an outer microelectronic component with respect to the textile fabric structure, a first distance is assigned, for example the distance value “1”, which specifies that the microelectronic component has a distance “1” from the portal processor. For the case in which, in the respective message, the distance from the reference position of the microelectronic component sending the message is inserted into the message and is transmitted to the microelectronic component to receive the message, the first microelectronic component transmits the distance value of “1” to the second microelectronic component in the first message, and the distance value received is incremented by a value of “1” by the second microelectronic component. The incremented value of “3” is then stored as an updated second distance value of the second microelectronic component. The second distance value is incremented by a value “1” and a third distance value is generated and transmitted to the third microelectronic component and stored there. The corresponding procedure is carried out in a corresponding way for all the microelectronic components of the textile fabric structure and, following the receipt of a message, the distance value respectively assigned to a microelectronic component is always updated with an item of distance information if the received distance value is less than the stored distance value.

A textile fabric structure has a large number of microelectronic components. Each microelectronic component is coupled to at least one microelectronic component adjacent to it via a bidirectional communications interface, the data transmission interface. In order to determine the respective distance of a microelectronic component of the textile fabric structure from a reference position, messages are exchanged between the microelectronic components, preferably between mutually adjacent microelectronic components, each message containing an item of distance information which specifies the distance of a microelectronic component sending the message or a microelectronic component receiving the message from the reference position (also designated a distance value), and each microelectronic component being set up in such a way that a distance of microelectronic components with respect to the reference position can be determined or stored from the distance information of a received message.

On account of the use of local information and the exchange of electronic messages, in particular between mutually directly adjacent microelectronic components, the procedure is very robust with respect to interference which occurs and the failures of individual microelectronic components or individual connections between the two microelectronic components if these connections are destroyed, for example when tailoring the textile fabric structure to a predefined shape.

According to one refinement of the invention, provision is made for the electrically conductive threads to be set up in such a way that they can be used for the power supply to the plurality of microelectronic components.

In the textile fabric structure, the conductive data transmission threads can be electrically conductive.

In a development of the textile fabric structure, the conductive data transmission threads are optically conductive.

The plurality of microelectronic components can be arranged in a regular grid in the textile fabric structure, preferably in a regular rectangular or square grid.

Particularly preferably, each microelectronic component from the plurality of microelectronic components is coupled to all the adjacent microelectronic components by means of the conductive threads and the conductive data transmission threads, that is to say, in the case of a regular rectangular grid, to four adjacent microelectronic components in each case.

In one development, the microelectronic components are processor units.

Preferably, at least one sensor can be coupled to the plurality of processor units. Such a sensor can be, for example, a pressure sensor, a heat sensor, a smoke sensor, an optical sensor or a noise sensor.

In one development, the textile fabric structure has at least one imaging element and/or a sound wave generating element and/or a vibration generating element, which is coupled to at least some of the plurality of microelectronic components.

This means that the textile fabric structure has at least one actuator integrated therein. The actuator is, for example, an imaging unit or a sound generating unit, preferably a liquid crystal display unit or a polymer electronic display unit, in general any type of display unit, or a loudspeaker which generates a sound wave, in general any type of element generating an electromagnetic wave. A further actuator which may possibly be provided is a vibration generating element.

According to another refinement, in the textile fabric structure, the plurality of microelectronic components is set up in such a way that, in order to determine a respective distance of the first microelectronic component from a reference position, electronic messages are exchanged between the first microelectronic component and a second adjacent microelectronic component of the textile fabric structure. Each message contains an item of distance information which specifies the distance of a microelectronic component sending the message or a microelectronic component receiving the message from the reference position. Furthermore, the plurality of microelectronic components is set up in such a way that the individual distance from the reference position can be determined or stored from the distance information of a received message.

The surface covering structure is preferably constructed as a wall covering structure or floor covering structure or ceiling covering structure.

The surface covering structure can have a textile interspersed uniformly with electrically conductive wires, at least over subregions of the textile fabric structure.

The textile interspersed with electrically conductive wires can be used in the surroundings of human beings in order to avoid “electromagnetic smog”. In this way, the “electromagnetic smog” can be shielded. However, care must be taken here that, if appropriate, specific regions, for example regions above capacitive sensors, must not be covered by the shielding.

According to a refinement, in the method for determining a distance, before determining the distance of the microelectronic components from the reference position, the local positions of the microelectronic components within the textile fabric structure are determined in that, starting from a microelectronic component at an initiation point of the textile fabric structure, in each case position determining messages, which have at least one row parameter z and one column parameter s, which contain the row number and column number of the microelectronic component sending the message or the row number and column number of the microelectronic component receiving the message within the textile fabric structure, are transmitted to the adjacent microelectronic components of the textile fabrics structure and the following steps are carried out by the respective microelectronic components. If the row parameter in the message received is higher than the previously stored row number of the microelectronic component, the individual row number of the microelectronic component is assigned to the row parameter value z of the message received. If the column number in the message received is higher than the individual column number of the microelectronic component, then the stored column number is assigned the column parameter value of the message received. If the individual row number and/or the individual column number has been changed on account of the method steps depicted above, then new position measurement messages with new row parameters and new column parameters are generated, which in each case contain the row number and column number of the microelectronic component sending the message or the row number and column number of the microelectronic component receiving the message, and these are transmitted to an adjacent microelectronic component of the textile fabric structure.

By means of this development, the concept according to the invention of the local message exchange between mutually adjacent microelectronic components is extended further, since already the local positions of the individual microelectronic components within the textile fabric structure according to this concept are based on local position information which results only from an item of position information obtained from an immediately adjacent microelectronic component. This permits a procedure which is very fault-tolerant within the context of the self-organization of the textile fabric structure.

According to another development of the invention, in an iterative method, the individual distance value of the microelectronic component of the textile fabric structure is changed if the previously stored distance value is greater than the distance value received in the respectively received message and increased by a predefined value. Furthermore, for the case in which a microelectronic component of the textile fabric structure changes the individual distance value, in the method, this microelectronic component generates a distance measurement message and sends it to the adjacent microelectronic components of the textile fabric structure, the distance measurement message in each case containing the individual distance as an item of distance information or the distance value of the receiving microelectronic component from the portal processor.

The distance value can be increased by a value increased by a predefined value with respect to the individual distance value, preferably by the value “1”.

The invention is suitable in particular for use in the following areas of application:
building automation, in particular to increase domestic convenience,
alarm systems with determination of position and optional determination of the weight of an intruder,
automatic visitor guidance at trade fairs during an exhibition or in a museum,
for a guidance system in an emergency situation, for example in an aircraft or in a train, in order to indicate to the passengers the route to an emergency exit,
in textile concrete constructions, in which textile fabric structures can be used to detect possible damage,
obtaining information in order to draw up statistics as to how much time customers spend in the regions in a business.

Clearly, the invention can be seen in that desired electronic data processing and optionally desired sensors or indicating elements and communications network constituents are integrated into a wall, floor or ceiling covering known per se.

In addition to a basic fabric preferably consisting of artificial fibers (electrically nonconductive threads), a textile fabric structure according to the invention contains conductive threads, preferably conductive warp and weft threads, which preferably consist of metal wire, for example copper, polymer filaments, carbon filaments or other electrically conductive wires. If metal wires are used, a coating of nobler metals, for example gold or silver, is preferably used as a corrosion prevention agent in the presence of humidity or aggressive media. Another possibility consists in insulating metal threads by applying an insulating varnish, for example polyester, polyamide imide or polyurethane.

In addition to electrically conductive fibers, optical fibers made of plastic or glass can also be used as data transmission threads.

The basic fabric of the textile fabric structure is preferably produced in a thickness which is matched to a thickness of the microelectronic components to be integrated, also called microprocessor modules in the following text, for example sensors, light-emitting diodes and/or microprocessors. A sensor can be, for example, a pressure sensor, a heat sensor, a smoke sensor, an optical sensor or an acoustic sensor. A distance of the optically and/or electrically conductive fibers can preferably be chosen such that it matches a connection pattern of the microelectronic components to be integrated.

Even though the following exemplary embodiment describes a carpet arrangement, the invention is not restricted to a carpet but can be applied to any element suitable for surface cladding or surface covering.

The textile fabric structure according to the invention with integrated microelectronics, processor units and/or sensors and/or actuators, for example indicator lamps, is intrinsically fully functional and can be fixed under various types of surface coverings. Here, mention should be made by way of example of nonconductive textiles, floor coverings made of carpet, parquet, plastic, drapes, roller blinds, wall coverings, insulating mats, tent roofs, plaster layers, screed and textile concrete. The fixing is preferably carried out by means of adhesive bonding, laminating or vulcanizing.

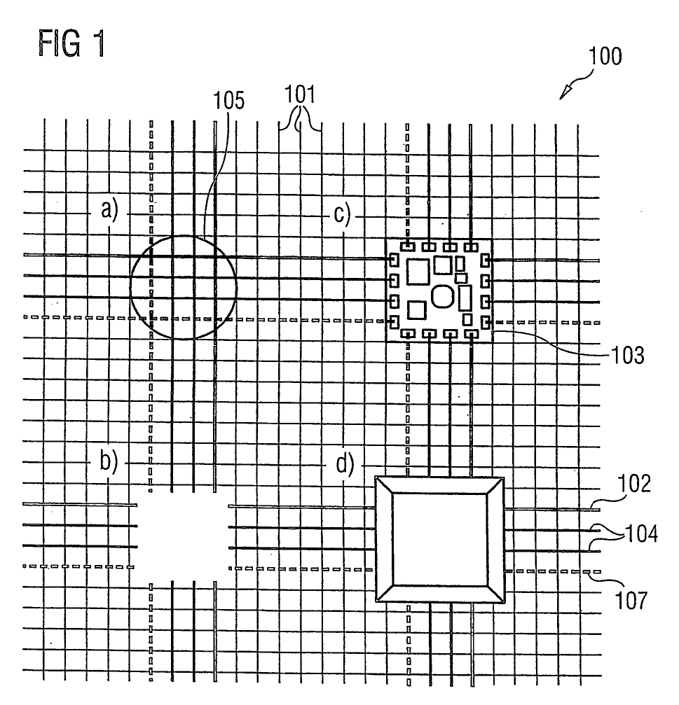

In FIG. 1, a schematic illustration of a textile fabric structure 100 according to an exemplary embodiment of the invention is shown. The textile fabric structure 100 according to the invention has a coarse mesh fabric as basic structure, which is formed of nonconductive threads 101. Furthermore, the textile fabric structure 100 has electrically conductive threads 102, 107. The electrically conductive threads 102 are used as a ground for the microelectronic components 103 to be integrated into the textile fabric structure 100. The electrically conductive threads 107 are used for the power supply of the microelectronic components 103 to be integrated into the textile fabric structure 100. Furthermore, the textile fabric structure 100 has conductive threads 104, which are used for data transmission from and to the microelectronic components to be integrated.

The electrically conductive threads 102, 107 and the conductive data transmission threads 104 are preferably placed in the fabric in a square grid, so that a square grid of crossing points 105 is formed in the textile fabric structure 100; one region of such a crossing point is marked by a) in FIG. 1.

Furthermore, in the region of such a crossing point, which is marked by b) in FIG. 1, the electrically conductive threads 102, 107 and the conductive data transmission threads 104 are removed, which forms a gap in the textile fabric structure 100.

In the region c) of FIG. 1, a microelectronic component (microelectronic module) 103 is arranged in a gap 105 in the textile fabric structure 100, the electrically conductive threads 102 and 107 and the conductive data transmission threads 104 being coupled to the microelectronic module 103, in order to supply the microelectronic module 103 with electrical power and to provide a data transmission line for the microelectronic module 103. In the textile fabric structure 100 according to the invention, each microelectronic module 103 is preferably arranged at a respective crossing point 105 of the electrically conductive threads 102 and 107 and the conductive data transmission threads 104 and are subsequently coupled to the electrically conductive threads 102 and 107 and the conductive data transmission threads 104, which lead up to the microelectronic module 103 from four sides.

The coupling between the microelectronic module 103 and the electrically conductive threads 102 and 107 and the conductive data transmission threads 104 can be implemented by means of making contact with a flexible printed circuit board or by means of what is known as wire bonding.

In the region d) of FIG. 1, a microelectronic module 103 is shown schematically which is encapsulated in order to insulate the coupling region (contact points) between microelectronic module 103 and the electrically conductive threads 102 and 107 and the conductive data transmission threads 104 and, moreover, to provide mechanically robust and water-resistant protection.

The textile fabric structure 100 according to the invention in each case has a microelectronic module 103 at a plurality of crossing points 105. Such an “intelligent” textile fabric structure can form as a basic layer or as an intermediate layer of a wall or floor covering or other types of technical textiles. It can, for example, also be used as a layer of a textile concrete construction. The microelectronic modules 103 of the textile fabric structure can be coupled to a large number of different types of sensors and/or actuators. For instance, these can be LEDs, indicating elements or displays, in order to indicate information which is transmitted to the microelectronic modules.

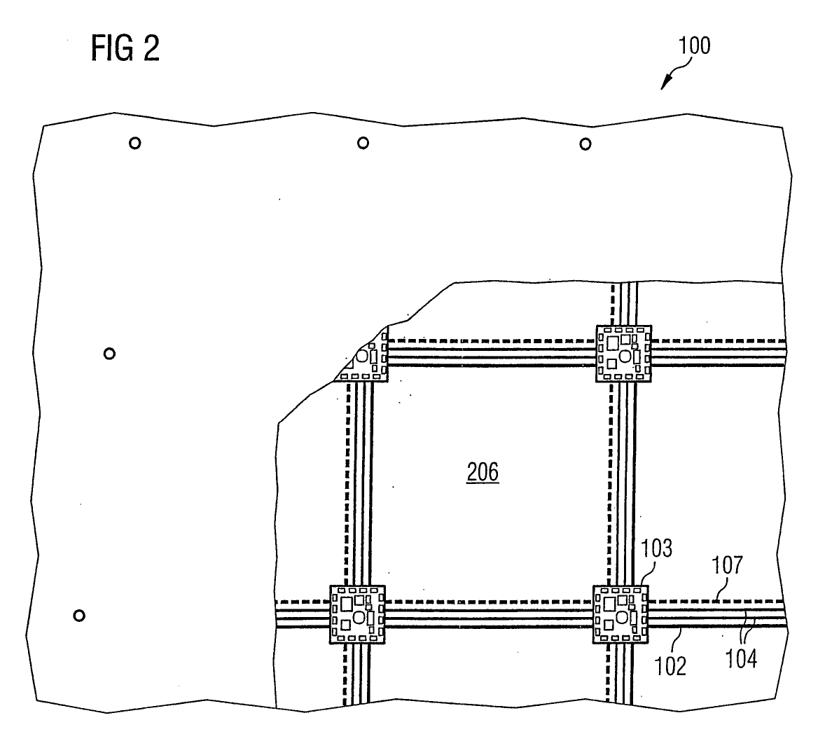

FIG. 2 shows an exemplary embodiment of what is known as an intelligent carpet. In the bottom right corner of FIG. 2 there is illustrated a coarse mesh basic fabric 206, into which conductive threads 102, 104 and 107 are woven in a square grid. At crossing points 105 of the conductive threads 102, 104 and 107, microelectronic modules 103 are arranged in the coarse mesh basic fabric 206. Thus, a regular grid of microelectronic modules 103 is produced, which in each case have contact made with supply and data lines on four sides. The microelectronic modules 103 additionally being provided with an encapsulation and with a light-emitting diode. Furthermore, in the rear left part of FIG. 2, a carpet is fixed on the textile fabric structure 100.

The textile fabric structure 100 according to the invention with integrated microelectronics, sensors and/or actuators, for example indicator lamps, is intrinsically fully functional and can be fixed under various types of surface coverings. Here, mention should be made by way of example of nonconductive textiles, floor coverings made of carpet, parquet, plastic, drapes, roller blinds, wall coverings, insulating mats, tent roofs, plaster layers, screed and textile concrete. The fixing is preferably carried out by means of adhesive bonding, laminating or vulcanizing. In order to avoid “electromagnetic smog” in the surroundings of human beings, a textile uniformly interspersed with electrically conductive wires can be used over the textile fabric structure according to the invention for shielding. However, care must be taken here that, if appropriate, specific regions, for example regions above capacitive sensors, must not be covered by the shielding.

The textile fabric structure according to the invention with integrated microelectronics is preferably coupled to a central control unit, for example a simple personal computer, at a point on the edge of the textile fabric structure.

By using simple algorithms, the microelectronic modules begin to organize themselves. If a textile fabric structure which has a network of microelectronic modules is connected, that is to say is set operating, then a learning phase begins, after which each microelectronic module knows its physical position in the grid. Furthermore, routes for data flows through the grid are automatically configured, which means that sensor or display information can be led around defective regions of the textile fabric structure. As a result of the self-organization of the network, defective regions are detected and circumvented. As a result, the network of microelectronic modules is also still serviceable if the textile fabric structure is cut to a shape which is predefined by the respective intended use. Furthermore, the self-organization has the effect that no manual installation effort is needed for the network of microelectronic modules.

The method for determining distances between microelectronic components 103 of the textile fabric structure 100 and the self-organization will be explained by using the following figures.

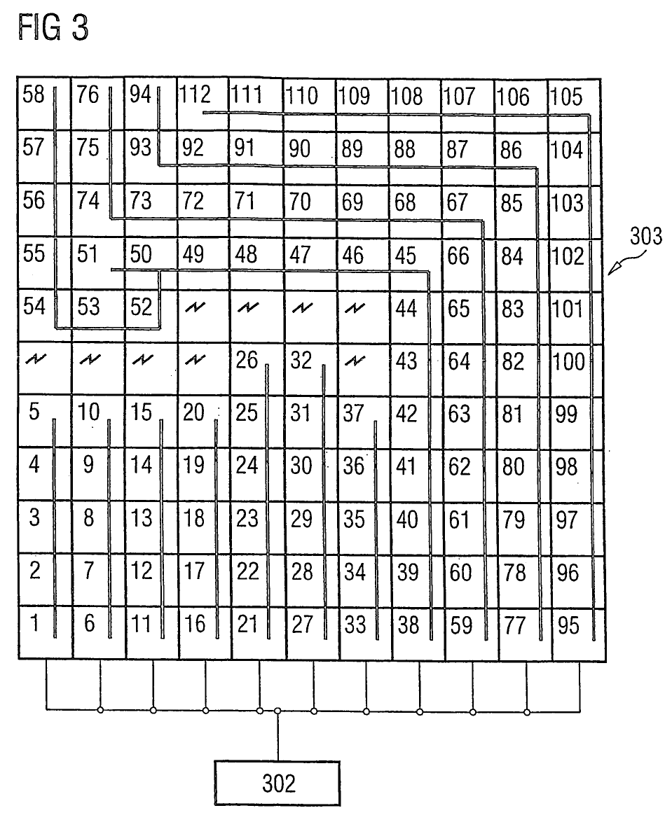

FIG. 3 shows a schematic illustration of a regular square 11×11 network of microelectronic modules, which are numbered consecutively in FIG. 3, of a textile fabric structure according to the invention in which an example of self-organization is shown. The regular square 11×11 network of FIG. 3 has nine defective microelectronic modules, which are identified in the figure by a “flash”. The lines drawn in show new connecting routes of the individual microelectronic modules which are obtained by means of the method after the nine defective microelectronic modules have failed and are thus no longer available for a serviceable connecting route. The new connecting routes drawn in have been obtained by means of the method for determining distances between microelectronic components.

In general terms, in a first phase of the method for determining the distance between microelectronic components, what is known as self-organization, carries out
self-detection of the local positions of the individual microelectronic components within the textile fabric structure and thus the overall shape of the textile fabric structure;
self-organization of routing paths starting from the portal processor 302 to each microelectronic component 103 in the textile fabric structure 100, in such a way that, within a predefined maximum number of time cycles, each microelectronic component can obtain an electronic message supplied by the portal processor 302.

In a second phase, the actual use of the textile fabric structure 100, for example within the context of displaying the visual data or generating sound, the data is sent by the portal processor 302 to the microelectronic components 103, that is to say transmitted, as a result of which the visual data (“images”) or sounds are built up by means of actuators which are coupled to the microelectronic components in the textile fabric structure 100. Conversely, the microelectronic components 103 can also transmit data detected by means of sensors, for example pressure or visual sensors, to the portal processor. In the following text, without restricting the general applicability, the method will be explained by using image data, that is to say display units (indicating units) are coupled to the individual microelectronic components 103 of the textile fabric structure 100.

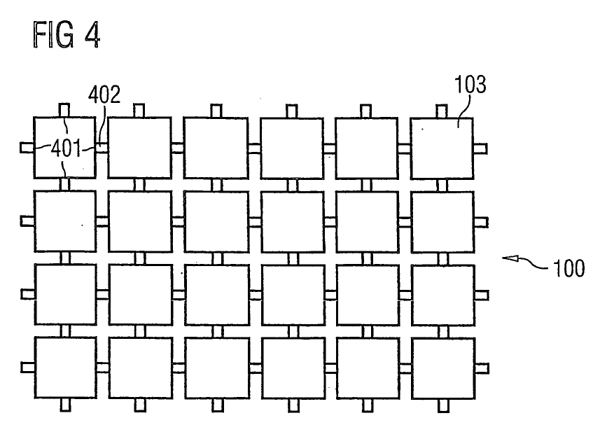

For the case in which they have a rectangular shape, preferably a square shape, as illustrated in FIG. 4, the microelectronic components 103 are in each case coupled via each side of the square via one of the communications interfaces 401 per microelectronic component 103, thus four communications interfaces 401 in each case, to the data transmission threads 104 (also called bidirectional connections in the following text) of the textile fabric structure and, via said threads, are coupled via the electrically conductive threads 102 and 107 (also called electric lines 402 in the following text) in each case to the microelectronic component 103 immediately adjacent to a respective microelectronic component 103.

Expressed in other words, this means that in each case a message exchange between two immediately mutually adjacent microelectronic components is made possible but not an immediate, that is to say direct, message exchange over a greater distance than the immediate neighborhood of a microelectronic component 103.

The self-organization is carried out by means of the method known from T. F. Sturm et al. (discussed above).

In the method for determining the interspacing of microelectronics components of a textile fabric structure with respect to at least one reference position by exchanging electronic messages between mutually adjacent microelectronic components, a first message is generated by a first microelectronic component, the first message containing a first item of distance information, which contains the distance of the first microelectronic component or the distance of a second microelectronic component receiving the first message from the reference position. The first message is sent by the first microelectronic component to the second microelectronic component. Depending on the item of distance information, the distance of the second microelectronic component from the reference position is determined or stored. Furthermore, a second message is generated by the second microelectronic component, which contains a second item of distance information, which contains the distance of the second microelectronic component or the distance of the third microelectronic component receiving the second message from the reference position. The second message is sent by the second microelectronic component to the third microelectronic component. Depending on the second item of distance information, the distance of the third microelectronic component from the reference position is determined or stored. The method steps described above are carried out for all the interconnected microelectronic components of the textile fabric structure.

Therefore, after this method has been carried out, the respective position of each microelectronic component within the textile fabric structure and its distance with respect to at least one reference position has been determined merely by using local information.

Clearly, this aspect of the invention can be seen in the fact that an architecture developed for microsystems and there for micro data display devices and sensors, and algorithms developed for the purpose, have been transferred to the macrosystems for building services technology and trade fair technology, the necessary microelectronic components being embedded in the textile fabric structure, on which elements of a covering can be fixed.

In this way, a plethora of possible applications opens up, which are explained in more detail in the following text.

The reference position can in principle be any desired; the reference position is preferably a position at which there is a portal processor, described below, which drives the microelectronic components of the textile fabric structure and initiates the communication from outside the textile fabric structure. The portal processor can be a microelectronic component of the textile fabric structure or an additional processor. Furthermore, the reference position can be a position within the textile fabric structure, in this case a microelectronic component preferably being arranged at the reference position and being assigned to the latter. In this case, the reference position is preferably located at the edge, that is to say in the highest or lowest row or the left-hand or right-hand column for the case in which the microelectronic components are arranged in rows and columns in the form of a matrix in the textile structure. The transmission of information into or out of the textile fabric structure is preferably carried out by means of the portal processor exclusively via at least some of the microelectronic components located at the edge of the textile fabric structure.

Clearly, this procedure means that, starting from an “initiating microelectronic component” at the reference position, normally at the edge of the textile fabric structure, that is to say at an outer microelectronic component with respect to the textile fabric structure, a first distance is assigned, for example the distance value “1”, which specifies that the microelectronic component has a distance “1” from the portal processor. For the case in which, in the respective message, the distance from the reference position of the microelectronic component sending the message is inserted into the message and is transmitted to the microelectronic component to receive the message, the first microelectronic component transmits the distance value of “1” to the second microelectronic component in the first message, and the distance value received is incremented by a value of “1” by the second microelectronic component. The incremented value of “2” is then stored as an updated second distance value of the second microelectronic component. The second distance value is incremented by a value “1” and a third distance value is generated and transmitted to the third microelectronic component and stored there. The corresponding procedure is carried out in a corresponding way for all the microelectronic components of the textile fabric structure and, following the receipt of a message, the distance value respectively assigned to a microelectronic component is always updated with an item of distance information if the received distance value is less than the stored distance value.

A textile fabric structure has a large number of microelectronic components. Each microelectronic component is coupled to at least one microelectronic component adjacent to it via a bidirectional communications interface, the data transmission interface. In order to determine the respective distance of a microelectronic component of the textile fabric structure from a reference position, messages are exchanged between the microelectronic components, preferably between mutually adjacent microelectronic components, each message containing an item of distance information which specifies the distance of a microelectronic component sending the message or a microelectronic component receiving the message from the reference position (also designated a distance value), and each microelectronic component being set up in such a way that a distance of microelectronic components with respect to the reference position can be determined or stored from the distance information of a received message.

On account of the use of local information and the exchange of electronic messages, in particular between mutually directly adjacent microelectronic components, the procedure is very robust with respect to interference which occurs and the failures of individual microelectronic components or individual connections between the two microelectronic components if these connections are destroyed, for example when tailoring the textile fabric structure to a predefined shape.

According to a refinement, in the method for determining a distance, before determining the distance of the microelectronic components from the reference position, the local positions of the microelectronic components within the textile fabric structure are determined in that, starting from a microelectronic component at an initiation point of the textile fabric structure, in each case position determining messages, which have at least one row parameter z and one column parameter s, which contain the row number and column number of the microelectronic component sending the message or the row number and column number of the microelectronic component receiving the message within the textile fabric structure, are transmitted to the adjacent microelectronic components of the textile fabric structure and the following steps are carried out by the respective microelectronic components. If the row parameter in the message received is higher than the previously stored row number of the microelectronic component, the individual row number of the microelectronic component is assigned to the row parameter value z of the message received. If the column number in the message received is higher than the individual column number of the microelectronic component, then the stored column number is assigned the column parameter value of the message received. If the individual row number and/or the individual column number has been changed on account of the method steps depicted above, then new position measurement messages with new row parameters and new column parameters are generated, which in each case contain the row number and column number of the microelectronic component sending the message or the row number and column number of the microelectronic component receiving the message, and these are transmitted to an adjacent microelectronic component of the textile fabric structure.

By means of this development, the concept according to the invention of the local message exchange between mutually adjacent microelectronic components is extended further, since the local positions of the individual microelectronic components within the textile fabric structure according to this concept are already based on local position information which results only from an item of position information obtained from an immediately adjacent microelectronic component. This permits a procedure which is very fault-tolerant within the context of the self-organization of the textile fabric structure.

According to another development of the invention, in an iterative method, the individual distance value of the microelectronic component of the textile fabric structure is changed if the previously stored distance value is greater than the distance value received in the respectively received message and increased by a predefined value. Furthermore, for the case in which a microelectronic component of the textile fabric structure changes the individual distance value, in the method, this microelectronic component generates a distance measurement message and sends it to the adjacent microelectronic components of the textile fabric structure, the distance measurement message in each case containing the individual distance as an item of distance information or the distance value of the receiving microelectronic component from the portal processor.

The distance value can be increased by a value increased by a predefined value with respect to the individual distance value, preferably by the value “1”.

In summary, the invention provides a textile fabric structure which serves the same chassis for integrated microelectronics. This textile fabric structure can be fixed under virtually any desired floor, ceiling and/or wall covering. Thus, large “intelligent areas” can be produced, which can be used as sensor or indicating surfaces. By means of the method for self-organization, the textile fabric structure with integrated microelectronics can be cut into virtually any desired shape without microelectronic modules removed during tailoring or coupling lines removed between the microelectronics modules having any effect. Faulty or missing microelectronic modules are circumvented by means of appropriate routing such that the function of all the functioning microelectronics modules is still maintained and the effort for installation of such an “intelligent area” remains very small.

What is claimed is:

1. A textile fabric structure comprising:
a plurality of microelectronic components, which are arranged in the textile fabric structure;
electrically conductive threads, which couple the plurality of microelectronic components to one another;
conductive data transmission threads, which couple the plurality of microelectronic components to one another; and
electrically nonconductive threads,
wherein the conductive threads and the conductive data transmission threads at the edge of the textile fabric structure are each provided with an electric interface and a data transmission interface.

2. The textile fabric structure as claimed in claim 1, wherein the electrically conductive threads are used to supply power to the plurality of microelectronic components.

3. The textile fabric structure as claimed in claim 1, wherein the conductive data transmission threads are electrically conductive.

4. The textile fabric structure as claimed in claim 1, wherein the conductive data transmission threads are optically conductive.

5. The textile fabric structure as claimed in claim 1, wherein the plurality of microelectronic components are arranged in a regular grid in the textile fabric structure.

6. The textile fabric structure as claimed in claim 1, wherein each of the plurality of microelectronic components is coupled on a plurality of sides to the conductive threads and the conductive data transmission threads.

7. The textile fabric structure as claimed in claim 1, wherein the microelectronic components are processor units.

8. The textile fabric structure as claimed in claim 7, wherein at least one sensor is coupled to the plurality of processor units.

9. The textile fabric structure as claimed in claim 1, further comprising at least one of an imaging element, a sound wave generating element, and a vibration generating element, coupled to at least some of the plurality of microelectronic components.

10. The textile fabric structure as claimed in claim 1, wherein the plurality of microelectronic components are set up such that, in order to determine a respective distance of a first microelectronic component from a reference position, electronic messages are exchanged between the first microelectronic component and a second adjacent microelectronic component of the textile fabric structure, each message containing an item of distance information which specifies a distance of a microelectronic component sending the message or a microelectronic component receiving the message from the reference position, and
wherein the plurality of microelectronic components are set up such that the individual distance from the reference position is determined or stored from the distance information of a received message.

11. A surface covering structure, wherein a surface covering is fixed on a textile fabric structure as claimed in claim 1.

12. The surface covering structure as claimed in claim 11, wherein the fixing is carried out by means of at least one of adhesive bonding, laminating, and vulcanizing.

13. The surface covering structure as claimed in claim 11, wherein the surface covering structure is formed as a structure selected from the group consisting of a wall covering structure, a floor covering structure, and a ceiling covering structure.

14. The surface covering structure as claimed in claim 11, wherein a textile layer interspersed uniformly with electrically conductive wires is applied at least over subregions of the textile fabric structure.

15. A method for determining the interspacing of the microelectronic components of the textile fabric structure as claimed in claim 1 and at least one reference position by exchanging electronic messages between mutually adjacent microelectronic components, the method comprising the steps of:
generating a first message by a first microelectronic component, the first message containing a first item of distance information, which contains a distance of the first microelectronic component or a distance of a second microelectronic component receiving the first message from the reference position;
sending the first message by the first microelectronic component to the second microelectronic component;
determining or storing, depending on the distance information, the distance of the second microelectronic component from the reference position;
generating a second message by the second microelectronic component, wherein the second message contains a second item of information, which contains the distance of the second microelectronic component or a distance of a third microelectronic component receiving the second message from the reference position;
sending the second message by the second microelectronic component to the third microelectronic component; and
determining or storing, depending on the second item of distance information, the distance of the third microelectronic component from the reference position,
wherein the method steps are carried out for all of the microelectronic components of the textile fabric structure.

16. The method as claimed in claim 15, further comprising the step of:
before determining the distance of the microelectronic components from the reference position, determining local positions of the microelectronic components within the textile fabric structure by, starting from a microelectronic component at an initiation point of the textile fabric structure, in each case position determining messages, which have at least one row parameter z and one column parameter s, which contain the row number and column number of the microelectronic component sending the message or the row number and column number of the microelectronic component receiving the message within the textile fabric structure, are transmitted to adjacent microelectronic components of the textile fabric structure and the following steps are carried out by the respective microelectronic component:
if the row parameter in the message received is higher than a previously stored row number of the microelectronic component, assigning the individual row number of the microelectronic component to the row parameter value z of the message received;
if the column parameter in the message received is higher than the individual column number of the microelectronic component, then the stored column number is assigned the column parameter value of the message received; and
if the individual row number and/or the individual column number has been changed on account of the method steps depicted above, then generating new position measurement messages with new row parameters and new column parameters, which in each case contain the row number and column number of the microelectronic component sending the message or the row number and column number of the microelectronic component receiving the message, and transmitting these row and column numbers an adjacent microelectronic component of the textile fabric structure.

17. The method as claimed in claim 15,
wherein, in an iterative method, an individual distance value of the microelectronic component of the textile fabric structure is changed if a previously stored distance value is greater than a distance value received in the respectively received message and increased by a predefined value, and
wherein, for a case in which a microelectronic component of the textile fabric structure changes the individual distance value, this microelectronic component generates and sends a distance measurement message to adjacent microelectronic components of the textile fabric structure, the distance measurement message in each case containing the individual distance as an item of distance information or the distance value of the receiving microelectronic component from the portal processor.

18. The method as claimed in claim 17, wherein the distance value has a value increased by a value increased by a predefined value with respect to the individual distance value.

19. A textile fabric structure comprising:
a plurality of microelectronic components arranged in the textile fabric structure;
electrically conductive thread means for coupling the plurality of microelectronic components to one another; and
conductive data transmission thread means for coupling the plurality of microelectronic components to one another,
wherein the conductive thread means and the conductive data transmission thread means at the edge of the textile fabric structure are each provided with an electric interface and a data transmission interface.

20. The textile fabric structure as claimed in claim 19, wherein each of the plurality of microelectronic components is coupled on a plurality of sides to the conductive thread means and the conductive data transmission thread means.

21. The textile fabric structure as claimed in claim 19, wherein the microelectronic components are processor means.

22. The textile fabric structure as claimed in claim 21, wherein at least one sensor is coupled to the plurality of processor means.

23. A system for determining the interspacing of the microelectronic components of the textile fabric structure as claimed in claim 19 and at least one reference position by exchanging electronic messages between mutually adjacent microelectronic components, the system comprising:
means for generating a first message by a first microelectronic component, the first message containing a first item of distance information, which contains a distance of the first microelectronic component or a distance of a second microelectronic component receiving the first message from the reference position;
means for sending the first message by the first microelectronic component to the second microelectronic component;
means for determining or storing, depending on the distance information, the distance of the second microelectronic component from the reference position;
means for generating a second message by the second microelectronic component, wherein the second message contains a second item of information, which contains the distance of the second microelectronic component or a distance of a third microelectronic component receiving the second message from the reference position;
means for sending the second message by the second microelectronic component to the third microelectronic component; and
means for determining or storing, depending on the second item of distance information, the distance of the third microelectronic component from the reference position.
